(19) United States
(12) Patent Application Publication
(10) Pub. No.: US 2002/0133452 A1
(43) Pub. Date: Sep. 19, 2002

(54) Associate web site shopping method

(76) Inventor: Hsiang-Chun Lu, Taipei (TW)

Correspondence Address: BIRCH STEWART KOLASCH & BIRCH, PO BOX 747, FALLS CHURCH, VA, 22040-0747, US

(21) Appl. No.: 09/808,120

(22) Filed: Mar. 15, 2001

(51) Int. Cl. G06F 17/60

(52) U.S. Cl. 705/37; 705/26

(57) ABSTRACT

According to the invention, a main web site provides consumers a hyperlink element linked to an associate web site. When a consumer selects this hyperlink element, the main web site will transmit the consumer's ID and confirmation code to the associate web site to confirm the identity of the consumer. When the consumer wants to purchase the commodity sold by the associate web site, the main web site receives the trade information transmitted from the associate web site and thereby bills the consumer. Finally, the main web site sends an order to the associate web site and provides the receiver's name and address. The associate web site then sends out the commodity to the receiver according to the trade information and the receiver's name and address.

### BACKGROUND OF THE INVENTION

1. Field of Invention

The invention relates to an associate web site shopping method and, more particularly, to an associate web site shopping method in which consumers can link from a main web site to an associate web site for shopping via hyperlinks by transmitting a confirmation code to the associate web site.

2. Related Art

With the development in network technologies, using networks to conduct various commercial activities has become a new business model. After a company sets up a web site, consumers can log on to the web site through a network to browse the content of the web site and select desired commodities or services.

Taking the Internet as an example, if a company wants to use the Internet to conduct business activities, a WWW web site in the hypertext transmission protocol (HTTP) format can be set up in a server. A consumer can browse the content of the web site using any web browser from a personal computer (PC). When the consumer is interested in a particular commodity or service provided in the web site, he can directly order it on the Internet. The company can use various kinds of trade mechanisms, such as credit card or electronic wallet payment, to bill the consumer.

However, due to the following drawbacks existing in the above trade mechanisms, consumers are often less willing to purchase on the networks.

First, trade activities via network are always insecure. When a consumer wants to purchase some commodity or service on a network, he has to enter his personal data, such as his name, address, and credit card number, and transmit these personal data to the company's web site. Nevertheless, data transmission on the network goes through many nodes, where hackers can intercept the data at any node, causing personal data releases.

Furthermore, consumers have to register the personal data at different web site databases when shipping from different web sites, which is very inconvenient. As more and more commodity or service providers start to use the network to do their businesses, it is less likely that a consumer will stay with the same web site and purchase all commodities he needs. Therefore, if the consumer has to enter his personal data every time he logs onto a new web site, he may not be willing to purchase on the network.

### SUMMARY OF THE INVENTION

In view of the foregoing problems, it is then an objective of the invention to provide an associate web site shopping method, which can greatly increase the consumer's will to purchase on the network.

It is another objective of the invention to provide an associate web site shopping method that has a higher web trade security.

It is yet another objective of the invention to provide an associate web site shopping method so that consumers do not have to enter their personal data as often when shopping online.

To achieve the above objectives, the disclosed method utilizes a main web site to provide consumers a hyperlink element linking to an associate web site. When a consumer selects this hyperlink element, the main web site will transmit the consumer's ID and confirmation code to the associate web site for verifying the consumer's identity. When the consumer purchases some commodity or services sold at the associate web site, the main web site receives trade information sent from the associate web site and thereby bills the consumer. Then, the main web site puts an order and provides the receiver's name and address to the associate web site. The associate web site then sends out the commodity according to the trade information and receiver's name and address provided by the main web site.

Since in the disclosed method consumers are able to purchase at the associate web site without the need to register personal data, they are more willing to log on and purchase at the associate web site through a network.

In the disclosed method the main web site and the associate web site only interchange data such as consumer's Ids, confirmation codes, and receiver's names and addresses. Other personal data such as consumer's credit card numbers or E-mail accounts are not transmitted over the network. Therefore, the method can effectively reduce the risk of consumer's data being released and intercepted. That is, the disclosed method has a higher level of security.

### BRIEF DESCRIPTION OF THE DRAWINGS

FIG. 1 is a flowchart showing the procedure of the associate web site shopping method according to a preferred embodiment of the invention.

### DETAILED DESCRIPTION OF THE INVENTION

The invention of an associate web site shopping method will be apparent from the following detailed description, which proceeds with reference to the accompanying drawing.

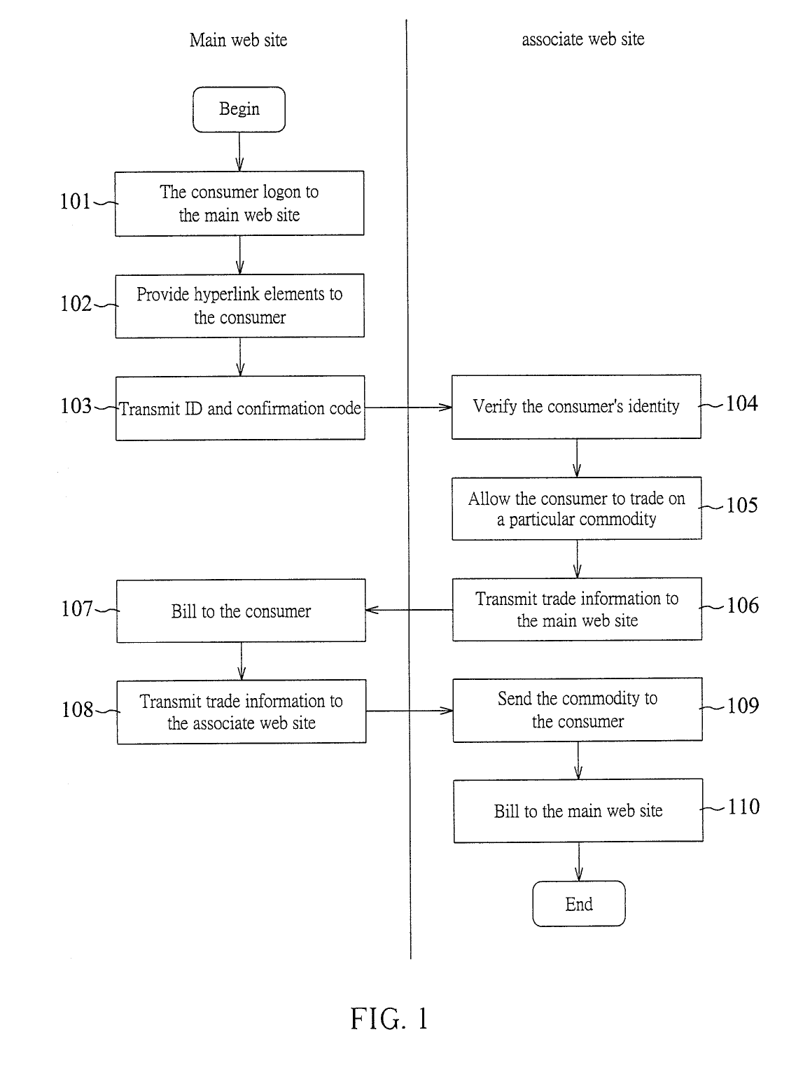

With reference to FIG. 1, a preferred embodiment of the disclosed method 1 first allows a consumer to log on to a main web site in step 101. Before successfully logging onto the main web site, the consumer has to register his personal data in the main web site. Such personal data include, but are not limited to, an ID, a password, a name, an address and a credit card number. After registering his personal data, the consumer can verify his identity by simply providing the ID and the password while logging in. Of course, if he does not register his personal data, the consumer can still browse the web page content in the main web site and enjoy some free services. However, only after registering his personal data can the consumer perform various kinds of trades on the main web site, e.g., purchasing a commodity or service.

In step 102, the main web site provides the consumer a hyperlink element linking to an associate web site. After the consumer selects this hyperlink element, he can link to the associate web site. The hyperlink element provided to the consumer by the main web site can be a text or graphic hyperlink. For example, the main web site can display a banner to the consumer. After the consumer clicks on this banner, he is linked to the corresponding associate web site.

When the consumer selects a hyperlink element, the main web site will transmit the consumer's ID and confirmation code to the associate web site in step 103 for the associate web site to verify the consumer's identity. Here the consumer's ID refers to the consumer's ID registered in the main web site or an ID assigned to the consumer by the main web site. The confirmation code refers to an encrypted code generated by the main web site according to the consumer's personal data following an algorithm. Its purpose is to verify the consumer's identity and whether the consumer is hyperlinked from the main web site. How to verify the consumer's identity will be explicitly explained hereinafter.

After the associate web site receives the consumer's ID and confirmation code transmitted from the main web site, step 104 proceeds to verify the consumer's identity accordingly. The verifying method can vary according to different situations. For example, the main web site can provide the associate web site a checking mechanism to check the confirmation code. Thus, when the ID and confirmation code transmitted from the main web site are received, the checking mechanism can be directly employed to perform checks and to verify the consumer's identity. The checking method performed by the checking mechanism on the confirmation code can vary according to different methods of forming the confirmation code. For example, if the confirmation code is obtained by performing bit operations on each character in the consumer's ID that shifts each bit to the right by two positions to obtain a new character, then the checking mechanism then performs an inverse operation on the confirmation code to shift each bit to the left by two positions and compares the inverted result to determine whether it is the same as the consumer's ID. If they agree, then the consumer is indeed a consumer hyperlinked from the main web site.

In step 105, the associate web site receives a trading action requested by the consumer about a particular commodity. In the current embodiment, the associate web site provides commodity or service related information, such as its appearance, introduction, price, etc, in a hypertext markup language (HTML) file to the consumer so that the consumer can browse through all commodities or services sold on the associate web site and thereby determine whether he wants to buy anything. If the consumer determines to purchase a particular commodity or service, he can select the item and quantity by, for example, click on it using a mouse.

In step 106, the associate web site will provide trade information related to this trading action to the main web site. The so-called trade information includes the commodity or service name, price, quantity, and the consumer ID of the person who performs the trading action. It should be noted that the reason for the associate web site to transmit the trade information to the main web site is because the consumer may be not registered in the associate web site. Therefore, the associate web site cannot bill to the consumer. Suppose the consumer wants to pay by credit card, the associate web site cannot send the bill to the credit card company because it does not have the information.

After receiving the trade information transmitted from the associate web site, the main web site bills the consumer according to the trade information in step 107. For example, if the consumer uses a credit card, the main web site will read in the credit card number from the personal data registered by the consumer and utilizes a credit card payment mechanism to request payment from the credit card bank according to the commodity name, quantity and price recorded in the trade information.

In step 108, the main web site transmits the receiver's name and address along with the trade information to the associate web site and thus puts in an order. After receiving the order, the associate web site then proceeds to step 109 to send out the commodity according to the received receiver's name and address and the trade information. In step 110, the associate web site bills to the main web site.

It should be noted that the receiver's name is not necessarily the consumer's name and the receiver's address may not be the consumer's address. For example, if the commodity is a birthday gift for a friend, the consumer can assign the commodity to be sent to his friend place with his friend as the receiver. The consumer can also assign the commodity to be sent to a particular convenience store so that the consumer can pick it up after work.

According to the associate web shopping method, the consumer can purchase in the associate web site without the need to register his personal data therein, therefore, he is more willing to purchase at the associate web site through a network.

In the disclosed method the main web site and the associate web site only interchange data such as consumer's Ids, confirmation codes, and receiver's names and addresses, other personal data such as consumer's credit card numbers, E-mail accounts, etc are not transmitted over the network. Therefore, the method can effectively reduce the risk of a consumer's data being released and intercepted. That is, the disclosed method has a higher level of security.

Certain variations would be apparent to those skilled in the art, which variations are considered within the spirit and scope of the claimed invention.

What is claimed is:

1. A associate web site shopping method implemented in a main web site, comprising the steps of:
providing the consumer a hyperlink element linking to the associate web site;
transmitting a consumer ID and a confirmation code to the associate web site for verifying the consumer's identity when the consumer selects the hyperlink element;
receiving trade information transmitted from the associate web site that is related to a purchase action performed by the consumer regarding a commodity sold at the associate web site;
billing to the consumer according to the trade information; and
placing an order with the associate web site whereby the associate web site sends out the commodity according to the trade information.

2. The method of claim 1 further comprising the step of accepting the bill according to the trade information from the associate web site.

3. The method of claim 1 further comprising the step of providing the associate web site a confirmation mechanism for the associate web site to verify the consumer's identity before transmitting the ID and the confirmation code to the associate web site.

4. The method of claim 1 further comprising the step of accepting a confirmation message regarding the confirmation code from the associate web site after transmitting the ID and the confirmation code to the associate web site.

5. The method of claim 1, wherein the trade information includes the ID, the confirmation code, the commodity data, and the commodity quantity.

6. The method of claim 1, wherein
the main web site further stores the receiver's name and the receiver's address; and
the associate web site sends out the commodity according to the receiver's name and the receiver's address.

7. A associate web site shopping method implemented in the associate web site, the method comprising the steps of:
receiving a consumer ID and a confirmation code transmitted from a main web site;
verifying the consumer's identity using the consumer ID and the confirmation code to verify that the consumer is hyperlinked from the main web site;
receiving a purchase action performed by the consumer about a commodity;
transmitting trade information related to the purchase action to the main web site;
receiving an order transmitted from the main web site; and
sending out the commodity according to the trade information.

8. The method of claim 7 further comprising the step of billing to the main web site according to the trade information.

9. The method of claim 7 further comprising the step of transmitting a confirmation message to the main web site after receiving the receiver's ID and the confirmation code.

10. The method of claim 7, wherein the trade information includes the ID, the confirmation code, the commodity data, and the commodity quantity.

11. The method of claim 1, wherein
the main web site further stores the receiver's name and the receiver's address; and
the associate web site sends out the commodity according to the receiver's name and the receiver's address.
